(19) United States
(12) Patent Application Publication
(10) Pub. No.: US 2015/0284960 A1
(43) Pub. Date: Oct. 8, 2015

(54) METHOD OF CONSTRUCTING A FLAT ROOF AND WELDING ROBOT

(71) Applicant: SIKA TECHNOLOGY AG, Baar (CH)

(72) Inventor: Matthias Bleibler, Winterthur (CH)

(73) Assignee: SIKA TECHNOLOGY AG, Baar (CH)

(21) Appl. No.: 14/440,977

(22) PCT Filed: Nov. 6, 2013
(86) PCT No.: PCT/EP2013/073128

§ 371 Date: May 6, 2015

(30) Foreign Application Priority Data
Nov. 6, 2012 (EP) 12191396.6

(51) Int. Cl. E04D 11/02; B32B 37/06; B32B 41/00; B32B 37/18

(52) U.S. Cl. CPC E04D 11/02; B32B 37/182; B32B 37/06; B32B 41/00; B32B 2419/06

(57) ABSTRACT

Method of constructing a sealed surface of a structure having plastic sheeting that is fixed on a supporting structure with fasteners having either thermoplastic or hot-melt coated thrust washers, wherein a welding robot is used for welding the plastic sheeting to the thrust washers, with such welding robot at least automatically detecting the thrust washers within the plastic sheeting, moving towards them, positioning a welding device relative to the thrust washers and carrying out the welding procedure, and optionally applying mechanical pressure to the weld joint for a pre-set time and at the same time cooling it.

### TECHNICAL FIELD

The invention relates to a method of constructing a sealed surface of a structure having plastic sheeting that is fixed on a supporting structure with fasteners having either thermoplastic or hot-melt coated thrust washers. It relates further to a welding robot which is suitable for carrying out this method.

### STATE OF THE ART

Flat roofs are a mass-produced component of modern buildings, both of hall-like industrial, commercial or cultural buildings, as well as of office and residential buildings. Their production according to state-of-the-art construction technology requires the installation of highly effective thermal insulation and a secure waterproofing seal that withstands all relevant stresses, particularly considerable suction forces during high winds.

FIG. 1 is a schematic illustration in the form of a cross-section diagram showing the structure of a flat roof 1 that fulfills these requirements. According to this, the flat roof 1 comprises a thermal insulation 5, spread flat over a supporting structure 3, that is secured to the supporting structure 3 by way of fasteners 7, which are fixed pointwise, and each comprise a thrust washer 7a affixed on the surface of the thermal insulation. A waterproofing seal 9, consisting of plastic sheeting that is welded together and also welded to the thrust washers 7a, is then applied on top of the thermal insulation 5 and the thrust washers 7a of the fasteners 7. The thrust washers are thermoplastic or hot-melt coated and can thus be welded to the plastic sheeting by way of induction welding.

The main issue regarding the installation process of the waterproofing membrane is its welding to the fasteners. Since the entire membrane is already spread out over the roof at the time of welding, it is impossible to visually detect the fasteners. While solutions and devices to detect and weld the fasteners do exist, the use of these devices has some inherent weaknesses: all devices require an installation engineer to manually position the induction welder above the fasteners. Built-in sensors, magnetic force or mechanical positioning aids partially facilitate this step. However, even in spite of these small aids, all existing devices require a lot of time for detecting and positioning. Moreover, vehicles in principle are known that are able to navigate to fastening positions based on predetermined coordinates, but connect only imprecisely to these due to inaccuracies in measurement and execution. In addition, the existing devices cannot carry out any quality control of the welding and thus cannot ensure that all fasteners have been sufficiently welded. For this reason, the number of fasteners used is increased by a safety factor, which creates a cost factor that should not be underestimated.

### DESCRIPTION OF THE INVENTION

The main task of the invention is thus an improved and particularly more productive and consequently more cost-effective method of the described type. Furthermore, a welding robot is to be included that is suitable for carrying out this method.

This task is solved in terms of the method aspect by a method with the features of Claim 1, and in terms of the device aspect by a welding robot with the features of Claim 8. Suitable further developments of the inventive idea are the subject of the dependent claims.

The invention is based on the consideration that known procedures for the construction of a building should be automated to such extent that an automated quality control is possible, while sufficiently taking into account the special design features of the production process that differentiate it from industrial production. Hence, both the obvious idea to apply glue locally to the plastic sheeting on an exactly specified fastener arrangement as well as the idea of controlling the welding process by way of fastener coordinates derived from the design drawings had to be rejected.

Rather, the invention comprises the idea of using a welding robot for welding the plastic sheeting to the thrust washers, with such welding robot at least automatically detecting the thrust washers within the plastic sheeting and moving towards them. The invention also comprises the aspect that a welding device is positioned relative to the thrust washers and then carries out the welding in this position. Finally there is the option to have the welding robot apply mechanical pressure to the weld joint for a pre-set time, while at the same time cooling it, and thus finishing the welding in a controlled manner.

From the current perspective, the proposed method is designed primarily for the construction of flat roofs, but it is also suitable for other structures or building components, such as pools, ponds, or disposal sites.

In one embodiment it is provided for constructing a flat roof having thermal insulation with insulation panels and a waterproofing seal applied on top of the insulation panels and thrust washers of the fasteners, with such waterproofing seal consisting of plastic sheeting welded to the thrust washers.

In the most basic case, automatic navigation happens within the boundaries of a pre-set area, e.g. limited to the width of a single plastic sheeting panel, while repositioning from one sheeting panel to the next can be done manually. A more advanced solution provides for navigation across all sheeting panels and thus basically for automatic execution of all weld joints on the entire flat roof. It is understood that the navigation signals have to be converted into control commands for at least one steered wheel or a steered caterpillar of the welding robot. There are algorithms available to the person skilled in the art for this conversion; therefore, a more detailed description can be neglected here.

A practical embodiment further provides for automatic quality control of the weld joints, resulting in reduced production time which is particularly cost-effective when taking into consideration the qualification required of workers carrying out such quality control inspections. One version of such embodiment provides for automatic measuring and evaluation of the welding temperature and the contact pressure of the welding equipment at several points on each thrust washer. It may be even more important to measure the contact pressure and temperature on cooling.

Alternative embodiments provide for either (a) automatic loading on tension of the respective weld joint and establishing and evaluating a characteristic curve of the tensile load, or (b) exciting the fastener to vibrations either acoustically or mechanically and then evaluating the vibration characteristics, or (c) measuring the thickness of the plastic sheeting above the fastener, both before and after the welding process, and evaluating the difference between these two values. Further alternative quality inspection methods for plastic weld joints may, in principle, also be used, as long as their use on the surface of a material panel covering the weld joint yields sufficiently meaningful results.

A further embodiment of the invention provides for storing data in the welding robot for post-processing that is relevant to the process, particularly information regarding the weld joint coordinates and the quality of the weld joints. This function particularly comprises data processing of all data required for quality assurance and documentation purposes that were recorded during the process, and their output, particularly in the form of a data log that can serve as acceptance certificate for the flat roof. This option can again achieve higher added value.

The proposed minimum configuration provides for the welding robot being designed for navigating, i.e. for finding the fasteners, at least in the boundary areas of the individual plastic sheeting. A further embodiment with a higher degree of automation provides for the welding robot automatically proceeding to the adjacent plastic sheeting panel once it has reached the end of one plastic sheeting panel. This option would allow for automatic navigation and movement control for basically an entire flat roof surface.

According to one embodiment that appears practical from the current perspective, joining within the proposed method is done by way of induction welding; however, other types of joining are basically also possible within the scope of the method.

Device aspects of the invention can be largely derived analogously to the aforementioned method aspects without being mentioned again at this point. It relates, for example, to the provision of a suitable navigation device for finding the fasteners below the waterproofing seal of the roof and the suitable steering of at least one wheel or a caterpillar of the welding robot chassis. Implementations of the device technology regarding these equipment aspects are in principle available in the state of the art, and a description is not required here.

The welding robot has optional clamping and cooling features for applying contact pressure upon weld joints between a material panel and an element located underneath it and for cooling the panel, with such features being time-controlled for controlling the clamping and cooling time. Embodiments without special clamping and cooling features are also conceivable, e.g. where only the weight of the robot that is applied to the weld joint temporarily provides sufficient pressure to clamp the plastic sheeting to the fastener or where such clamping and/or active cooling is dispensable due to the special selection of materials and welding parameters.

Furthermore, it should be pointed out that the suggested welding robot would ideally be equipped with means for automatic quality control of the weld joints, including in particular a temperature probe for measuring the welding temperature and at least one, but preferably several, pressure sensors for measuring the contact pressure on the material sheeting above one weldable element, as well as an evaluation device that is connected to the temperature probe and the pressure sensor, or each pressure sensor, to provide a combined evaluation of temperature and pressure signals according to a pre-stored algorithm for quality determination.

Furthermore, the welding device—for the purposes of a method with automatic quality assurance—is designed particularly as an induction welding device with associated temperature control means for controlling the welding temperature, a timing device for controlling the welding time, and a controllable clamping device to generate controllable contact pressure. The time control in particular features calculation means for calculating the welding time based on temperature signals from a temperature probe to determine the welding temperature.

In a further preferred embodiment, the welding robot comprises data processing means for processing process-relevant data, particularly regarding the position of weld joints and for quality control, and for storing said data in the welding robot, as well as an interface for the output of the stored data.

In a further embodiment of the proposed welding robot, the gross detection elements of the navigation system are designed as robot-local measuring means for determining the position of elements by way of induction, mechanical scanning or localization of the RFID chips attached to the elements. The embodiment further comprises fine detection means with three induction sensors that are positioned on the welding device in a geometric configuration aligned with the dimensions of the elements to be welded. As a general rule, other active principles can be used for implementing gross and fine detection means—also depending on the choice of material for the fasteners—particularly ultrasound or radio wave reflection methods, and the like.

Particularly in the optional version with an electively semi-automatic operation, the welding robot features in particular display means for displaying the fine positioning of the welding device with regard to the weldable element and/or for displaying process parameters, such as welding temperature, contact pressure during welding, welding time, contact pressure during cooling, or cooling time. These display means enable even poorly qualified operators to carry out the welding process quickly and in precisely the correct position as well as with optimum joining parameters.

### BRIEF DESCRIPTION OF THE DRAWING

The advantages and functionalities of the invention can be derived from the following description of embodiment examples and aspects, partially based on the figures. The figures show the following:

FIG. 1 Schematic cross-section view of a flat roof structure

FIG. 2 Schematic top view of the type of flat roof depicted in FIG. 1

FIG. 3 Schematic illustration of all essential components and sub-components of the procedure according to the invention and of a welding robot according to the invention

FIGS. 4A and 4B Schematic top view or perspective view of an embodiment of the welding robot according to the invention

FIG. 5 Schematic top view of welding robot segments

FIGS. 6A and 6B Schematic top view or perspective view of an embodiment of the welding robot according to the invention

FIGS. 7A and 7B Schematic top view or perspective view of an embodiment of the welding robot according to the invention

FIGS. 8A and 8B Two perspective views of an implementation example

FIG. 9 Sketch-like synoptic illustration of detection and evaluation means of further implementations of the welding robot according to the invention

### METHOD OF IMPLEMENTING THE INVENTION

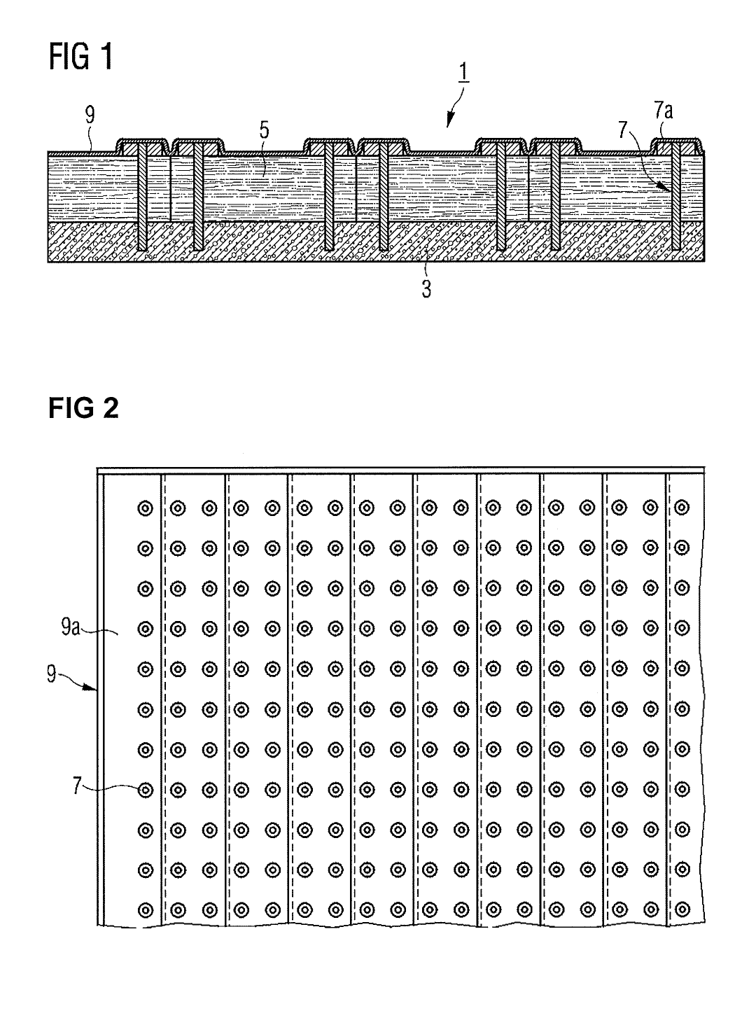

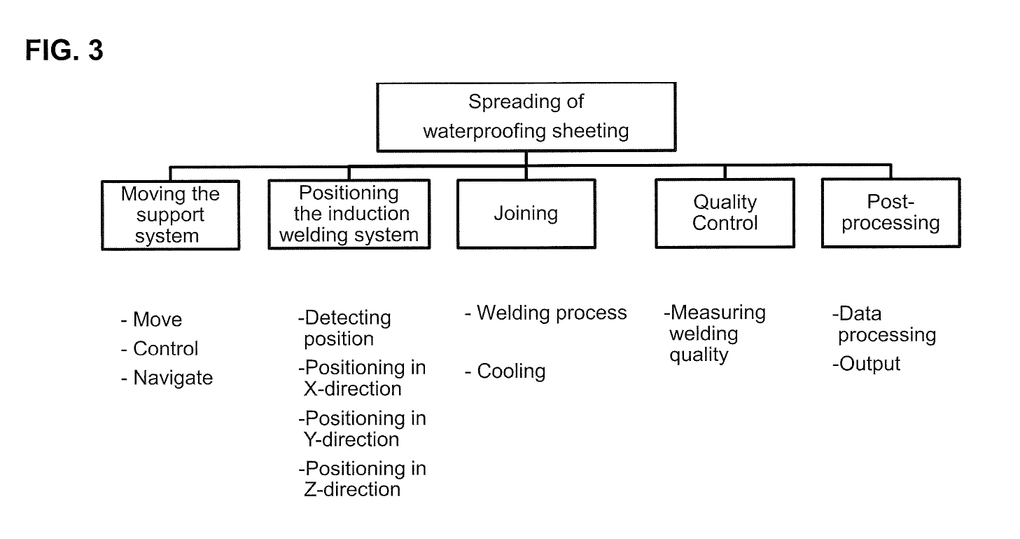

FIG. 2 shows a schematic top view of a corner area of a flat roof 1 which is constructed in accordance with FIG. 1. It shows that the waterproofing seal 9 is made up of plastic sheeting 9a that is welded together, with fasteners 7 arranged at regular intervals underneath. The arrangement of the fasteners 7 in areas close to the edge of the flat roof 1 is different than the arrangement of the fasteners in the middle section, which shows fewer fasteners. In the field, the arrangement often is not done at regular intervals as shown in the installation plan (also in FIG. 2) because, due to other construction details of the building that are not shown in the figure, fasteners have to be installed in different positions or such deviations in their positions occur due to a lack of care during the construction process.

In spite of these intentional or unintentional deviations from the installation plan, the waterproofing seal 9 must be correctly welded to all fasteners 7. This requires an exact detection of their actual position and applying one weld joint each in this actual position of the fastener. This can be ensured by implementing the method according to the invention and using a welding robot according to the invention.

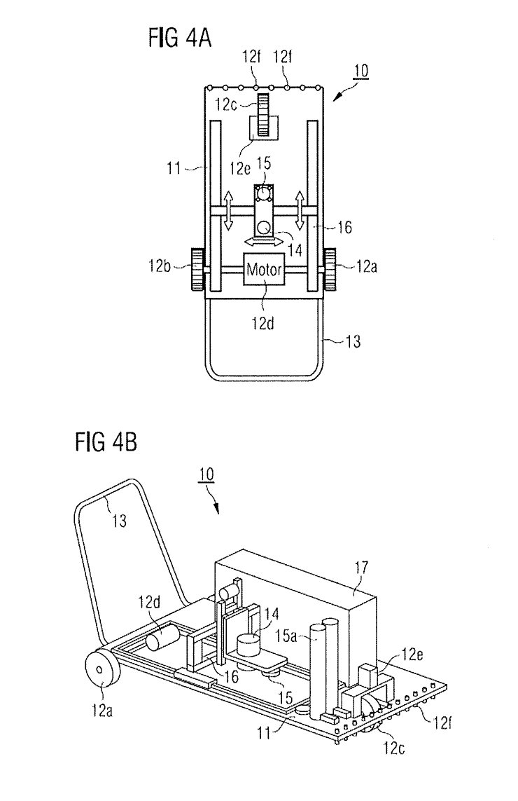

FIG. 3 shows—as a block diagram under method aspects—essential components (steps and partial steps) of a method according to the invention and at the same time provides, under equipment aspects, an illustration of essential functional components and elements of a welding robot designed for its implementation. The legend makes this figure self-explanatory, and a further description is not provided here.

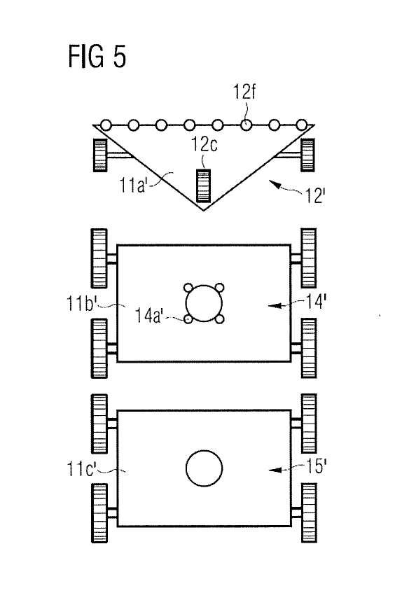

FIGS. 4A and 4B show a top view or perspective view of a welding robot 10 according to one embodiment of the invention, with essential functional components. A chassis 11 of the welding robot 10 has two rear wheels 12a, 12b that are mounted on a rigid axle and one single steerable front wheel 12c. An electric motor 12d is used to drive the non-steerable rear wheels 12a, 12b. A navigation and steering unit 12e is linked with the steerable front wheel 12c. Induction sensors 12f that form a part of this component group are mounted on the front edge of chassis 11. In addition, a guide handle 13 is mounted on the chassis for manual steering of the device.

The chassis carries an induction welding device 14 and a clamping and cooling device 15, each with associated sensors (not shown here), which are mounted on an xy-positioning device (linear axis system) relative to chassis 11 and are adjustable in terms of their position. A magnetic storage and output device 15a, which functionally is part of the clamping and cooling device 15, is mounted on the chassis in a fixed position. These parts implement the principle, based on magnetic force and thermal conduction, of clamping the waterproofing foil to the fasteners at the weld joints and cooling the weld joints, with metallic magnets of suitable size being placed on the weld joints from a tray, which then attach themselves to the weld joint because of the magnetic force with applied pressure and at the same time absorb heat from it, and are later collected again.

A control cabinet 17 is mounted on the chassis also in a fixed position; this cabinet houses the power supply and sensor data processing and control components which will be described in more detail later.

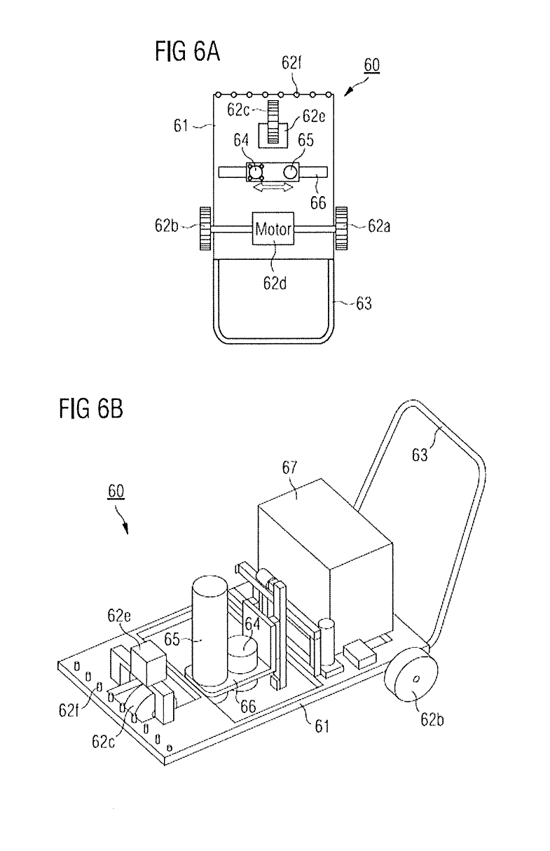

FIG. 5 is a conceptual sketch that shows the essential functional units of the welding robot depicted in FIGS. 4A and 4B as relatively autonomous units. These units comprise a navigation and steering unit 12′ with the steerable wheel 12c already mentioned and the sensors 12f that are part of the navigation system. In this illustration, the navigation and steering unit 12′ has an independent chassis part 11a′. A joining unit 14′ with associated sensors 14a′ and its own chassis 11b′ is shown as a further autonomous device. A clamping and cooling unit 15′ which also features its own chassis component 11c′ is shown as a further relatively autonomous unit. This figure serves to illustrate—aside from the basic functional structure of the welding robot—that different options are available with regard to the assembly of these functional components on a connected chassis or on several, relatively autonomous units.

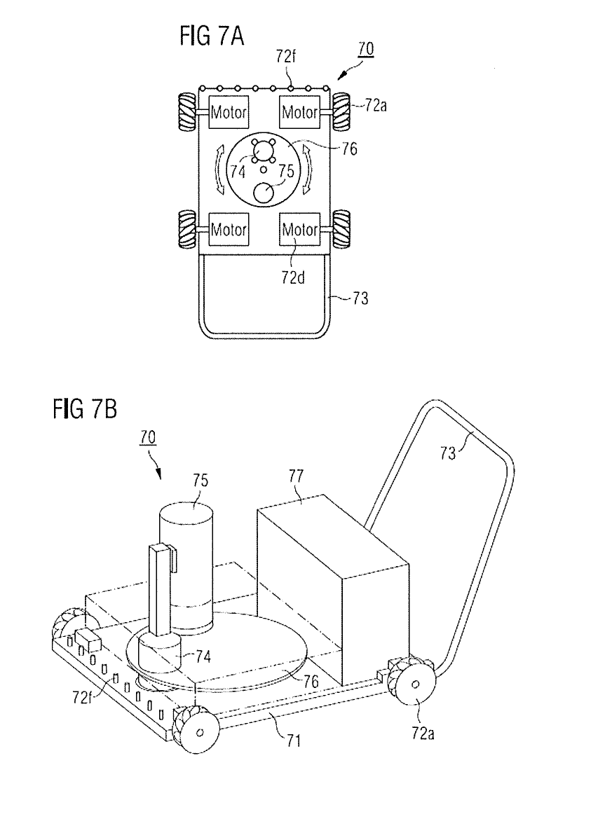

FIGS. 6A and 6B show a welding robot 60 that basically has a similar structure as welding robot 10 shown in FIGS. 4A and 4B and whose components are marked with reference numbers based on those designations. The welding robot 60 also features a three-wheel chassis 61 with one single steerable front wheel 62c, with an associated navigation and steering unit 62e with induction sensor 62f. The difference as compared to the above described embodiment is that the positioning device consists of a single-axle guiding mechanism 66 of the induction welding device 64 and clamping and cooling device 65 in chassis 61. The somewhat different illustration in this regard in FIGS. 6A and 6B clearly shows that the two most important functional components of the robot, i.e. the induction welding device and the clamping and cooling device, can be positioned either adjacent to each other (FIG. 6A) or one after the other (FIG. 6B) in the longitudinal direction of the chassis.

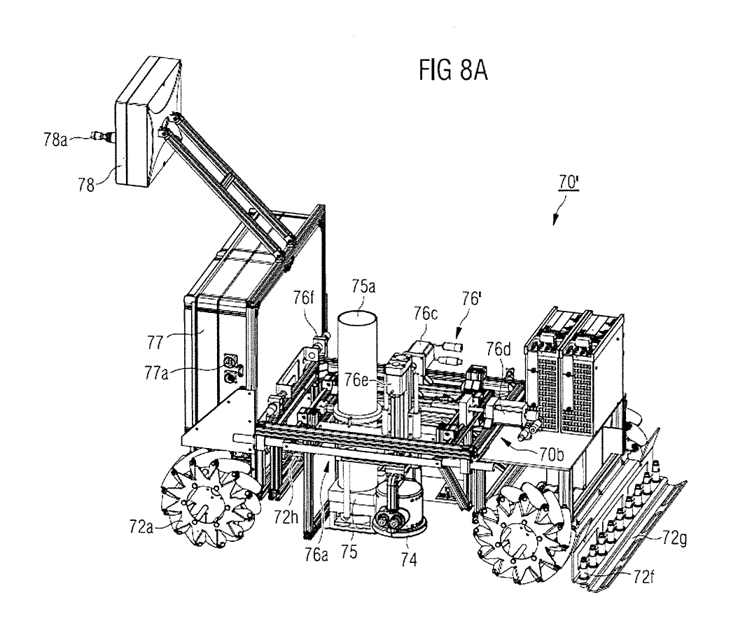

FIGS. 7A and 7B show, as a further embodiment, a welding robot 70, again with reference numbers for the most important components that are based on FIGS. 4A/B and 6A/B. The main differences as compared to the above described embodiments are that the welding robot 70 features a four-wheel chassis 71 with an all-wheel drive by four electric motors 72d and with special wheels 72a (so-called omni-directional wheels or Mecanum wheels), and instead of linear guidance has a rotating table 76 for the induction welding device 74 and the clamping and cooling device 75.

It should be pointed out that, aside from versions of the chassis and means for fine positioning of the welding device and of the clamping and cooling device on the chassis as shown in FIG. 4A through 7B, various other forms with different steering and drive principles, including the use of caterpillars or skids, are possible. It is also understood that many different means for manually guiding the robot are known from prior art.

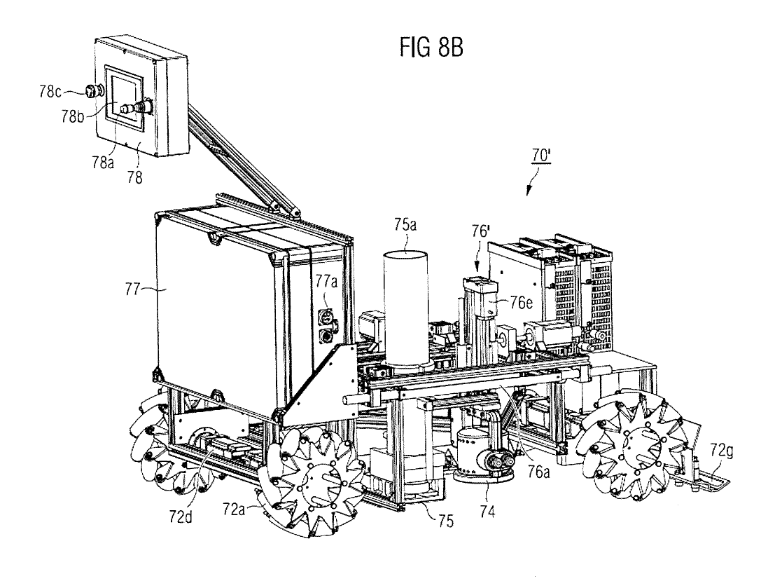

FIGS. 8A and 8B are two perspective views of a further embodiment example according to the invention, namely a welding robot 70′ whose basic structure is similar to the structure of the above-described welding robot 70 according to FIGS. 7A and 7B. Corresponding parts are marked with the same reference numbers as in FIGS. 7A and 7B, and these parts are not described again here.

The first deviation in the welding robot 70′ is the incorporation of a display and control panel 78 with a joystick 78a, a display field 78b and an emergency stop switch 78c on the control unit 77. The control unit further comprises connection sockets 77a for additional (manual) welding devices. There is also a clamping and protection strip 72g at the front edge of the welding robot 70′ for clamping the waterproofing sheeting panels, upon which the welding robot moves during its operation, to the subsurface and for protecting the sensors 72f. A magnetic storage and output device 75a is designated separately as part of the clamping and cooling device 75.

As compared to the embodiment according to FIGS. 7A and 7B, the technology for fine positioning of the welding device 74 and the clamping and cooling device 75 has been solved differently and shown in more detail: The solution is a fine positioning unit 76′ designed as a three-axle adjustment unit, with an X-axis linear guidance 76a, an Y-axis linear guidance 76b with the respective actuators 76c, 76d and a lifting device 76e for Z-axis adjustment of the induction welding device 74 and the clamping and cooling device 75 being designated separately as essential parts. A chassis component for compensating torsion resulting from level differences in the wheels is designated as 72h and the corresponding dampers on the chassis are designated as 76f. FIG. 8B also shows one of the drive motors 72d assigned to the Mecanum wheels 72a.

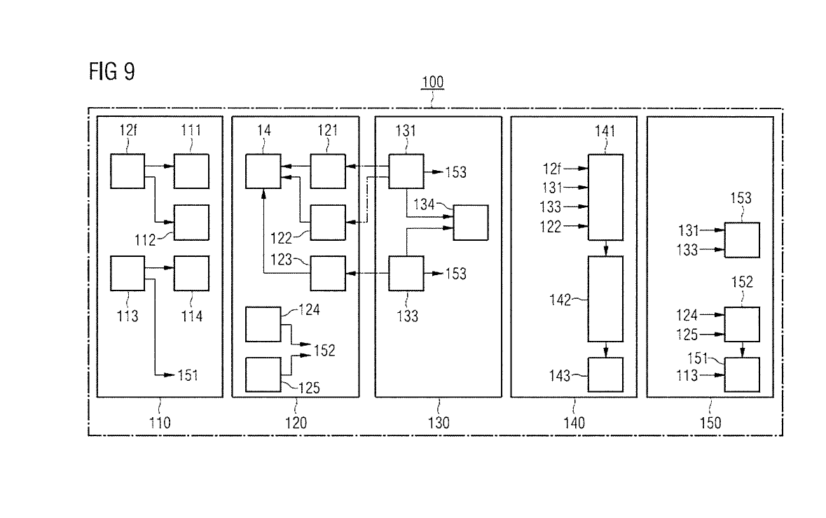

FIG. 9 shows a schematic synoptic illustration of sensor and data processing components of the proposed welding robot, which are partially not visible in

FIGS. 4A to 7B or not provided for in the embodiments shown there. FIG. 8 uses the same reference numbers to the extent that the components are already shown in FIGS. 4A and 4B.

The relevant sensor and data processing elements of the welding robot marked with reference number 100 in this synoptic illustration can basically be assigned to a positioning component 110, a joining component 120, a quality control component 130, a data processing/storage component 140 and a display component 150. For reasons of clarity, illustrations of the multiple signal connections between these components and their elements have be omitted in this figure; only a few very important connections are shown.

The positioning component 110 comprises induction sensors 12f as gross detection means for finding elements that are invisible under the material sheeting (in this regard, see above, particularly the description of FIGS. 1 and 2), which are connected to a steering control 111 and a drive control 112 for automatically moving toward the detected elements. The positioning component 110 further comprises a fine detection means 113 which may also be designed as induction sensors (and particularly with several close-range induction sensors). After having moved to one of the invisible elements, these fine detection means precisely determine the alignment of the welding device of the welding robot for this element. The fine detection means 113 are connected to a detector signal input of a coordinates control unit 114 that moves the welding device and the clamping and cooling device to the optimum joining or clamping and cooling position with a corresponding drive control of associated linear guidance (FIGS. 4A and 6A) or a rotating table (FIG. 7A). A special fine positioning display 151 in the display component 150 is assigned to the fine detection means 113.

In the joining component 120, temperature control means for controlling the joining temperature 121, a timing device 122 and pressure control 123 for controlling the clamping pressure during joining are assigned to the induction welding device 14. Correspondingly, the quality control component 130 comprises a T-probe 131 and at least one pressure sensor 133, both of which may be connected to the temperature and pressure control devices 121, 123 in the joining component for implementation of temperature or pressure control. Aside from that, these sensors 131, 133 are connected to an evaluation device 134 for combined evaluation in accordance with a pre-stored quality determination algorithm.

In the embodiment example, the joining component 130 further comprises a pressure detection device 124 and a time measuring device 125 for measuring the contact pressure during cooling of the weld joint and the interaction time of the contact pressure. The above-mentioned embodiment of the invention, where the contact pressure is achieved by placing suitable magnets on the weld joint, is specifically designed with sensory pressure measuring since, in the case of a faulty weld joint, the pressure value will deviate from the expected target value based on the magnet parameters. Here, contact and cooling times are determined by the time period from when the magnet is placed on the respective weld joint up to its removal. For practical purposes, correct measuring of this time period will also include monitoring of the temperature during cooling to avoid premature removal of the magnets from the weld joints. The data recorded by the recording means 124, 125 is displayed on a special display 152 of the display component 150, just like the welding temperature and the contact pressure during welding are shown on a display 153.

In the data processing/storage component 140, a data processing device 141, a data storage device 142 and a data output interface 143 are shown only generally; these form the essential functional sections of each component, and signal connections on the input side to the above-mentioned detection means are shown for the data processing device 141. As already mentioned earlier, the intention is not to provide a complete illustration or the statement that the data of all mentioned detection means must necessarily be processed and stored for post-processing.

Implementation of the invention is not limited to the examples and aspects as explained above; rather, a plurality of different versions is possible within the scope of execution by a person skilled in the art.

### LIST OF REFERENCE NUMBERS

1. Flat roof

3 Supporting structure

5 Thermal insulation

7 Fastener

7a Thrust washer

9 Waterproofing seal

9a Plastic sheeting

10, 60, 70, 70′, 100 Welding robot

11, 61, 71 Chassis

12, 12b, 12c; 62a, 62b, 62c; 72a Wheel

12d; 62d; 72d Electric motor

12e; 62e Navigation and steering unit

12f; 62f; 72f Induction sensors

13; 63; 73 Guide handle

14; 64; 74 Induction welding device

15; 65; 75 Clamping and cooling device

15a; 75a Magnetic storage and output device

16; 66; 76; 76′ Positioning device (guidance or rotary table)

17; 67; 77 Control cabinet

72 Clamping and protection strip

72h Level compensation means

76a X-axis linear guidance

76b Y-axis linear guidance

76c, 76d Actuator

76e Lifting device

76f Damper

77a Connection socket

78 Display and control panel

78a Joystick

78b Display field

78c Emergency stop switch

110 Positioning component

111 Steering control

112 Drive control

113 Fine detection means (induction sensors)

114 Coordinates control unit

120 Joining component

121 Temperature control device

122 Timing device

123 Pressure control

124 Pressure detection device

125 Time measuring device

130 Quality control component

131 T-probe

133 Pressure sensor

134 Evaluation device

140 Data processing/storage component

141 Data processing device

142 Data storage device

143 Data output interface

150 Display component

151 Fine positioning display

152 Display (for contact pressure and duration)

153 Display (for welding temperature and welding contact pressure)

1. Method of constructing a sealed surface of a structure having plastic sheeting that is fixed on a supporting structure with fasteners having either thermoplastic or hot-melt coated thrust washers;
a welding robot used for welding the plastic sheeting to the thrust washers; such welding robot being at least capable of automatically detecting the thrust washers within a plastic sheeting panel, moving to the position of said thrust washers, positioning a welding device relative to the thrust washers, and carrying out the welding while optionally applying mechanical pressure to the weld joint for a pre-set time and cooling it at the same time.

2. Method according to claim 1 of constructing a flat roof having thermal insulation with insulation panels and a waterproofing seal spread out on top of the insulation panels and thrust washers of the fasteners, with said waterproofing seal consisting of plastic sheeting welded to the thrust washers.

3. Method according to claim 1, with automatic quality control of the weld joints.

4. Method according to claim 3, with quality control being carried out by way of automatic measuring and evaluation of the welding temperature and the contact pressure of the welding equipment at several points on each thrust washer.

5. Method according to claim 3, with automatic loading on tension of the respective weld joint and establishing and evaluating a characteristic curve of the tensile load, or by exciting the fasteners to vibrations either acoustically or mechanically and then evaluating the vibration characteristics, or by measuring the thickness of the plastic sheeting above the fastener, both before and after the welding process, and evaluating the difference between these two values.

6. Method according to claim 1, with process-relevant data, being processed and stored in the welding robot for post-processing.

7. Method according to claim 1, with the welding robot automatically moving to the adjacent plastic sheeting panel at the end of a plastic sheeting panel.

8. A welding robot comprising the following:
a three- or four-wheel and/or caterpillar-equipped chassis
an electric drive for the wheels or caterpillars of the chassis
a welding device mounted on the chassis designed for pointwise welding of a material panel to weldable elements positioned underneath.
a navigation system for positioning control of the chassis, with the navigation system featuring gross detection means for detecting elements invisibly spread over a work surface underneath the material panel, and means for automatic quality control of the weld joints.

9. A welding robot according to claim 8, which further comprises:
a clamping and cooling device for applying contact pressure to weld joints between the material panel and each element positioned underneath, and for cooling of said weld joint, with time control for controlling the clamping and cooling time.

10. A welding robot according to claim 8, with position adjustment means for fine positioning of the welding device relative to one of the weldable elements each, and with such position adjustment means featuring fine detection means for detecting the outline of the element.

11. A welding robot according to claim 8, herein the quality control means comprise a temperature probe for measuring the welding temperature and at least one for measuring the contact pressure on the material panel above one weldable element each, as well as an evaluation device connected to the temperature probe and the one or several pressure sensors for combined evaluation of the temperature and pressure signals according to a pre-stored quality evaluation algorithm.

12. A welding robot according to claim 8 with data processing means for processing process-relevant data, and for quality control, and for storing said data in the welding robot, as well as an interface for the output of the stored data.

13. A welding robot according to one of claim 8, with the welding device designed as an induction welding device featuring a temperature control device for controlling the welding temperature, a timing device for controlling the welding time, and a controllable clamping device to generate controllable contact pressure applied by the welding equipment.

14. A welding robot according to claim 13, with the timing device featuring calculation means for calculating the welding time based on temperature signals from a temperature probe to determine the welding temperature.

15. A welding robot according to claim 8, with the gross detection means of the navigation system designed as robot-local measuring means for determining the position of the elements by way of induction, mechanical scanning or localization of the RFID chips attached to the elements.

16. A welding robot according to claim 10, with the fine detection means featuring at least three induction sensors that are positioned on the welding device in a geometric configuration aligned with the dimensions of the elements to be welded.

17. A welding robot according to claim 8 with control devices for manual control intervention at least for the operation of moving to a weldable element or a weld joint.

18. A welding robot according to claim 8 with display means for displaying the fine positioning of the welding device with regard to the weldable element and/or display means for displaying process.
